(19) United States
(12) Patent Application Publication
(10) Pub. No.: US 2020/0064131 A1
(43) Pub. Date: Feb. 27, 2020

(54) METHOD AND APPARATUS FOR MONITORING ELEVATION

(71) Applicant: 5DTECT IP PTY LTD

(72) Inventor: Christopher Antony Seymour, Kangaroo Point (AU)

(21) Appl. No.: 16/322,871

(22) PCT Filed: Aug. 3, 2017
(86) PCT No.: PCT/AU2017/050820

§ 371 Date: Feb. 1, 2019

(30) Foreign Application Priority Data
Aug. 3, 2016 (AU) 2016903049

(51) Int. Cl. G01C 5/06; G01L 13/06; G01L 15/00; G06F 16/29; G01L 9/08; G01L 19/14

(52) U.S. Cl. CPC G01C 5/06; G01L 13/06; G01L 19/14; G06F 16/29; G01L 9/08; G01L 15/00

(57) ABSTRACT

Elevation monitoring apparatus includes an enclosed base reference station (10) a 2000 m long, elongate housing (11) extends along the length of a traverse. A pair of conduits (12, 13) are filled with air (14) and water (15) respectively and extend through the elongate housing (11). 200 differential piezo pressure sensors (16) are spaced at 10 m intervals along the pair of conduits (12, 13) and are selected to sense the pressure difference between the respective fluids (14, 15). A dedicated microprocessor (17) associated with each pressure sensor (16) collects and distributes pressure difference data over a CANbus compatible network comprising twisted pairs (20) extending to the base reference station (10). A main data processor (21) relates the data to form a database of elevations. A modem (24) and antenna (23) outputs the data to remote management. A precision GPS unit (25) monitors the base reference elevation to assure the reference standard.

### FIELD

The present invention relates to methods of monitoring elevation and apparatus for use in the methods. The invention has particular application in the measurement and monitoring of settlement or subsidence of a rock or earth structure or of the solid surface of the earth, such as that due to compaction of the earth or rock structure or extraction of solid or fluid materials from beneath the surface.

### BACKGROUND TO THE INVENTION

When minerals such as coal or fluids such as groundwater or coal seam gas are extracted, it is common for the surface of the earth to subside. Similarly when rock or earth structures are erected, such as highway embankments, airports or tailings dams, the surface of the structure often subsides over time due to the compaction of the earth or rock in the structure.

It is frequently necessary to monitor the subsiding surface of the earth or the structure to determine the extent of subsidence, maintain quality control on construction and provide timely warning of the possibility of structural failure or hazards induced by the subsidence. Current monitoring methods, such as conventional survey, GPS survey, aerial survey or Satellite Synthetic Aperture Radar do not provide continuous monitoring and may interfere with ongoing works.

Monitoring subsidence resulting from coal seam gas (CSG) extraction is of particular interest in Australia and has been the subject of separate recent reports sponsored by the NSW Chief Scientist and the Commonwealth Department of the Environment, the reports being cited hereinafter. Both reports detail various methods of monitoring and measuring subsidence. A problem is to continuously monitor the elevation of a multiplicity of points to an appropriate level of accuracy, where the monitoring equipment is located where it is protected from ongoing works, is reliable for continuing operation over a period of many years, and is dynamically self-calibrating.

### SUMMARY OF THE INVENTION

In one aspect, the present invention resides broadly in a method of monitoring elevation along a traverse and including the steps of:

establishing a base reference point of known elevation on said traverse;

selecting a plurality of measurement points along said traverse;

interconnecting said base reference point and said plurality of measurement points by a pair of conduits, each said conduit being filled with a respective one of a pair of fluids having different densities;

continuously monitoring data corresponding to the pressure difference between the respective fluids at said base reference point and each said measurement point over a network;

relating said data for each of said measurement points to said known elevation to form a database of elevations; and

monitoring said database of elevations for changes in elevation at one or more of said measurement points.

The base reference point of known elevation may be located on a substrate or geology that is inherently stable. Alternatively, if such a locale cannot be guaranteed, the base reference point may be monitored by external means such as high precision radar altimetry, GPS, laser measurement or the like. Any variation in externally-derived elevation data for the base reference point may be used to calibrate the database of elevations.

The plurality of measurement points may be at any selected positions on the traverse. For example, in the case of a traverse along a made structure such as an earth-fill embankment, revetment, impoundment wall or other like structure, the measurement points may be evenly distributed at a selected pitch along the traverse. In a more heterogeneous environment, the measurement points may be located at the sites along the traverse which are expected to be more prone to settling or subsidence.

The conduits may be selected having regard to the nature of the fluids to be contained. As the fluid environment is relatively static and the relevant measure is head pressure, dynamic considerations such fluid drag and surface to volume ratios are largely immaterial. The conduits may therefore be of relatively small diameter. In the case of a water/air system, for example, a conduit internal diameter of 6 mm has been found sufficient. While a lesser bore may well work with this and particularly other fluid systems over distances of 2 km or more, it is anticipated that fluid drag and surface tension effects may adversely effect installation (filling) efficiency and measurement sensitivity. This of course will be highly dependent on conduit material choice, bore conformation and fluid choice.

The conduits are preferably formed of a material that is flexible enough to follow the traverse, move with the substrate and be installed with ease, while having a relatively high modulus to reduce kinking and transmission of low frequency oscillations to the fluid. For example, a high precision tubular material such as polyamide 11 or 12, HDPE or a like material selected for compatibility with the fluids may be used. Such precision tube may be adapted for use with push fit reusable connectors. However, it is envisaged that lesser-specified pipe will be adequate for the purposes of the invention such as low/medium density polyethylene resin drip irrigation pipe.

The fluids may comprise any selected fluids having a density difference amenable to the sensitivity of the means of measuring the gravimetric pressure difference between the conduits. The invention will be described hereinafter with reference to water/air fluids. However, it is equally envisaged that other systems may be used including liquid/liquid systems. Preferably, liquids are selected to have low vapour pressures to reduce the tendency to vapour locking. For example, 2-heptene in one conduit (Density: 0.701 g/mL at 25° C.(lit.); Vapor pressure: 88 mmHg (37.7° C.); Bp: 98° C.(lit.)) and water in the other conduit (Density: 0.997 g/mL at 25° C.(lit.); Vapor pressure: 47.1 mmHg (37.0° C.); Bp: 100° C.(lit.)) may be a suitable fluid pair.

The means for continuously monitoring data corresponding to the pressure difference between the respective fluids at the base reference point and each measurement point may be any known means of doing so. The need for continuous monitoring substantially rules out tube manometers as a practical solution, but a manometric/visual data capture scheme remains within the scope. Preferably, the continuous monitoring of the respective pressures is by means of pressure sensors such as piezo transducer devices. For example, each conduit may be associated with a pressure transducer at each measuring point. The transducers may be electronically bridged and feed pressure differential-related data to a data bus comprising the network. Alternatively, a single, differential-pressure, smart transducer assembly may be used. Such differential pressure transmitters may be designed with internal signal conditioning, and digital outputs including RS232, RS485, and CANbus compatible outputs. The data bus may include for example a twisted pair network or fibre optic network matched to the transducers. Excitation/operating voltage may be supplied over the data bus (such as POE).

The collective continuous monitoring of the data on the bus may be performed by monitoring means associated with the base reference point location or located elsewhere on the network. The monitoring means may include a microprocessor. The microprocessor may be addressable and report the recorded pressure at each transducer to a central data processor when polled.

The relating of the data for each of said measurement points to said known elevation to form a database of elevations may be done by data processing means associated with the local network, such as the aforementioned central data processor. Alternatively the local network may include data transmission means to deliver the raw data to remote said central data processor.

The processor may base its calculations on any suitable algorithm fore relating the relative elevations. For example the algorithm may be embodied by the equation:

Eₙ=E_{b}−10³.(Pₙ−P_{b})/g.(ρₐ−ρ_{b})

where:

E_{b}=Elevation of the base reference point, in meters

Eₙ=Elevation of measurement point n, in meters

P_{b}=Pressure difference between the respective fluids (a) and (b) at the base reference point, in Pascals (kgm⁻¹sec⁻²)

Pₙ=Pressure difference between the respective fluids (a) and (b) at the measurement point n, in Pascals (kgm⁻¹sec⁻²)

ρₐ=Density of fluid (a), in g cm⁻³

ρ_{b}=Density of fluid (b), in g cm⁻³

g=the gravitational constant—approximately 9.807 m sec⁻²

The database of elevations may be monitored for changes in elevation at one or more of the measurement points via interface with the central data processor by user interrogation, automatic signalling or both.

As the components used in performance of the method are a complex assembly, in most cases using delicate monitoring components including electronic components interconnected by a data bus, it is preferred that the assemblage be located in an elongate housing having an interior protected from the environment along the traverse. For example, the assemblage may be confined in a flexible plastic pipe. The pipe is preferably buried in the substrate to ensure that the pipe moves with the substrate, if it moves at all, to avoid false positive results for movement.

In a further aspect the present invention resides broadly in elevation monitoring apparatus for a traverse over a substrate and including:

a base reference station located at a base reference point of known elevation on said traverse;

an elongate housing extending from said base reference station along the length of said traverse, having an interior protected from the environment along the traverse and being secured relative to said substrate;

a pair of conduits, each said conduit being filled with a respective one of a pair of fluids having different densities, and extending from said base reference station through the interior of and substantially along the length of said elongate housing;

a plurality of pressure sensors spaced along the pair of conduits and selected to sense the pressure difference between the respective fluids at said base reference station and at a plurality of measurement points along said traverse defined by said spaced sensors;

monitoring means collecting data corresponding to said pressure difference between the respective fluids at said pressure sensors over a network;

data processing means relating said data for each of said measurement points to said known elevation to form a database of elevations; and

output means monitoring said database of elevations and producing an output of changes in elevation at one or more of said measurement points.

The base reference station may comprise a housing adapted to protect internal components from the environment and be securely located at the base reference point. The point of known elevation may be located on a substrate or geology that is inherently stable. Alternatively, if such a locale cannot be guaranteed, the base reference point may be monitored by external means such as high precision radar altimetry using the housing as a target, GPS with an antenna co-located with the housing, laser measurement of a target on the housing, or the like. Any variation in externally-derived elevation data for the base reference point may be used to calibrate the database of elevations.

The elongate housing may take any fit for purpose form. For example, the elongate housing may comprise a flexible plastic pipe. The elongate housing may be secured to the substrate by piers or anchors. However, an elongate housing comprising a pipe may be advantageously buried in the substrate to ensure that the pipe moves with the substrate, if it moves at all, to avoid false positive results for movement.

The plurality of measurement points may be at any selected positions on the traverse. For example, in the case of a traverse along a made structure such as an earth-fill embankment, revetment, impoundment wall or other like structure, the measurement points may be evenly distributed at a selected pitch along the traverse. In a more heterogeneous environment, the measurement points may be located at the sites along the traverse which are expected to be more prone to settling or subsidence.

The conduits may be selected having regard to the nature of the fluids to be contained. As the fluid environment is relatively static and the relevant measure is head pressure, dynamic considerations such fluid drag and surface to volume ratios are largely immaterial. The conduits may therefore be of relatively small diameter. In the case of a water/air system, for example, a conduit internal diameter of 6 mm has been found sufficient. While a lesser bore may well work with this and particularly other fluid systems over distances of 2 km or more, it is anticipated that fluid drag and surface tension effects may adversely effect installation (filling) efficiency and measurement sensitivity. This of course will be highly dependent on conduit material choice, bore conformation and fluid choice.

The conduits are preferably formed of a material that is flexible enough to follow the traverse, move with the substrate and be installed with ease, while having a relatively high modulus to reduce kinking and transmission of low frequency oscillations to the fluid. For example, a high precision tubular material such as polyamide 11 or 12, HDPE or a like material selected for compatibility with the fluids may be used. Such precision tube may be adapted for use with push fit reusable connectors. However, it is envisaged that lesser-specified pipe will be adequate for the purposes of the invention such as low/medium density polyethylene resin drip irrigation pipe.

The fluids may comprise any selected fluids having a density difference amenable to the sensitivity of the means of measuring the gravimetric pressure difference between the conduits. The invention will be described hereinafter with reference to water/air fluids. However, it is equally envisaged that other systems may be used including liquid/liquid systems. Preferably, liquids are selected to have low vapour pressures to reduce the tendency to vapour locking. For example, 2-heptene in one conduit (Density: 0.701 g/mL at 25° C.(lit.); Vapor pressure: 88 mmHg (37.7° C.); Bp: 98° C.(lit.)) and water in the other conduit (Density: 0.997 g/mL at 25° C.(lit.); Vapor pressure: 47.1 mmHg (37.0° C.); Bp: 100° C.(lit.)) may be a suitable fluid pair.

The plurality of pressure sensors may be selected from piezo transducer devices. For example, each conduit may be associated with a pressure transducer at each measuring point. The transducers may be electronically bridged and feed pressure differential-related data to a data bus. Alternatively, a single, differential-pressure, smart transducer assembly may be used. Such differential pressure transmitters may be designed with internal signal conditioning, and digital outputs including RS232, RS485, and CANbus compatible outputs.

Within the base reference station, the two fluid conduits may be terminated at two separate fluid reservoirs. The base reference station pressure sensor may measure the difference in pressure between the two reservoirs.

The monitoring means may include a data bus interconnection of the sensors. The data bus may include for example a twisted pair network or fibre optic network matched to transducers. Excitation/operating voltage may be supplied over the data bus (such as POE) or separately. A battery pack associated with the base reference station may supply power to the monitoring means.

The collective continuous monitoring of the data on the bus may be performed by monitoring means associated with the base reference station or located elsewhere on the network. The monitoring means may include a microprocessor. The microprocessor may be addressable and report the recorded pressure at each transducer to a central data processor when polled.

The relating of the data for each of said measurement points to said known elevation to form a database of elevations may be done by data processing means associated with the local network, such as the aforementioned central data processor. The central data processor may be housed in the base reference station. Alternatively the local network may include data transmission means associated with the base reference station to deliver the raw data to remote said central data processor.

The output means may include a user interface associated with the base reference station, remote user interrogation interface, automatic signalling and/or alarm or any combination thereof.

### BRIEF DESCRIPTION OF DRAWINGS

FIG. 1 is a transverse cross section of apparatus in accordance with the present invention, taken through the traversing part at a measurement point;

FIG. 2 is a longitudinal section detail of the apparatus of FIG. 1, detailing two measurement points;

FIG. 3 is a detail scheme of a base reference station of the apparatus of FIG. 1;

FIG. 4 is a cross section diagram of an earth fill dam, showing the typical location for installation of the apparatus of FIG. 1; and

FIG. 5 is a section diagram along a highway fill, again illustrating typical installation of the apparatus of FIG. 1.

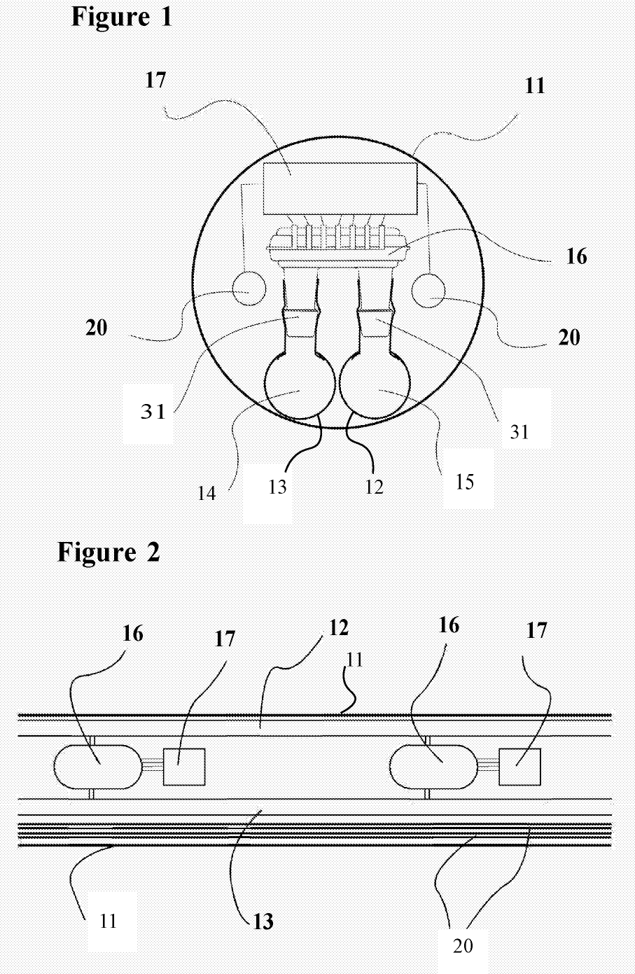

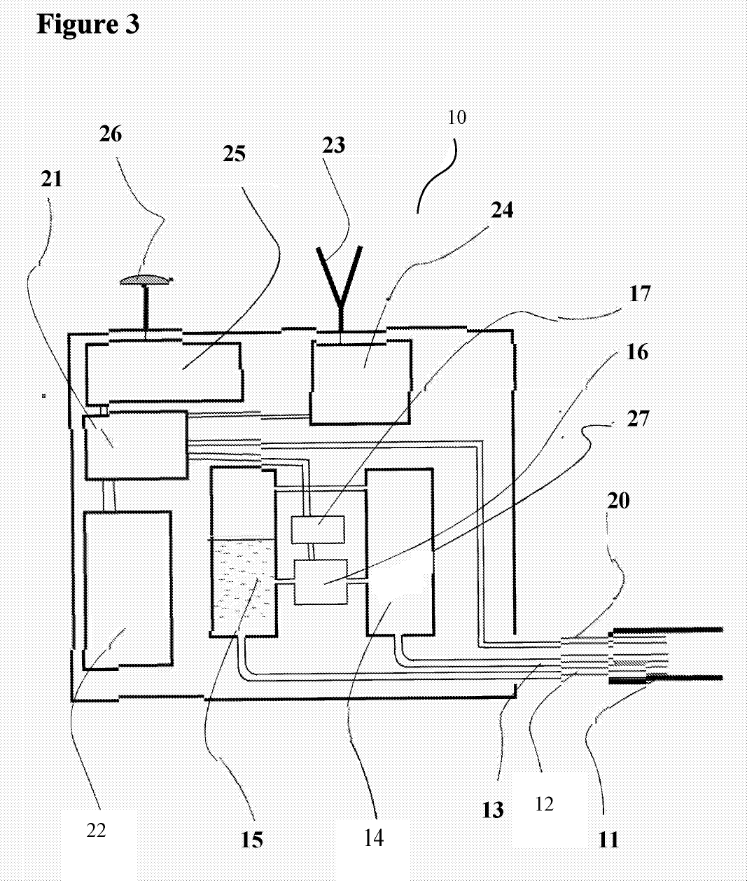

In the figures there is provided elevation monitoring apparatus for a traverse over a substrate and including an enclosed base reference station 10 (FIG. 3) located at a base reference point of known elevation on the traverse. A 2000 m long, elongate housing 11 is formed from 25 mm diameter hydraulic hose and extends from the base reference station 10 along the length of the traverse, and having an interior protected from the environment along the traverse. The elongate housing 11 is typically buried to a depth of 30 centimetres in the substrate.

A pair of conduits 12, 13 of 6 mm-bore, low/medium density polyethylene resin drip irrigation pipe are filled with air 14 and water 15 respectively and extend from the base reference station 10 through the interior of and substantially along the length of said elongate housing 11. 200 differential piezo pressure sensors 16 are spaced at 10 m intervals along the pair of conduits 12, 13 and are selected to sense the pressure difference between the respective fluids 14, 15 via barbed tail connectors 31. The 200 pressure sensors 16 provide discrete measurement points along the traverse.

Monitoring means comprises a dedicated microprocessor 17 associated with each pressure sensor 16 and collecting data corresponding to said pressure difference between the respective fluids 14, 15 at the pressure sensor 16 and distributing the data over a CANbus compatible network comprising twisted pairs 20 extending the length of the elongate housing 11 to the base reference station 10. The twisted pairs 20 include a power-over-network function to provide the low power necessary to drive the pressure sensors 16.

Data processing means includes a main data processor 21 relating the data for each of said measurement points to the known elevation to form a database of elevations. The main data processor also includes power management and is connected to a battery 22. Output means for monitoring the database of elevations and producing an output of changes in elevation at one or more of the measurement points is provided by a modem 24 and antenna 23, outputting the data to remote management.

The elevation of the base reference station 10 is assured by periodic reference to a precision GPS unit 25 and its associated GPS antenna 26. The pressure sensor 16 associated with the base reference station 10 measures the differential pressure between the air 14 and water 15 in terminal reservoirs 27, 30 respectively, which terminate the respective conduits 13, 12.

The 200 measurement points defined by the sensors 16 may be evenly distributed at a selected pitch along the traverse, as described above, to service a made structure such as an earth-fill embankment, revetment, impoundment wall or other like structure. In a more heterogeneous environment, the sensors 16 may be located at the sites along the traverse which are expected to be more prone to settling or subsidence.

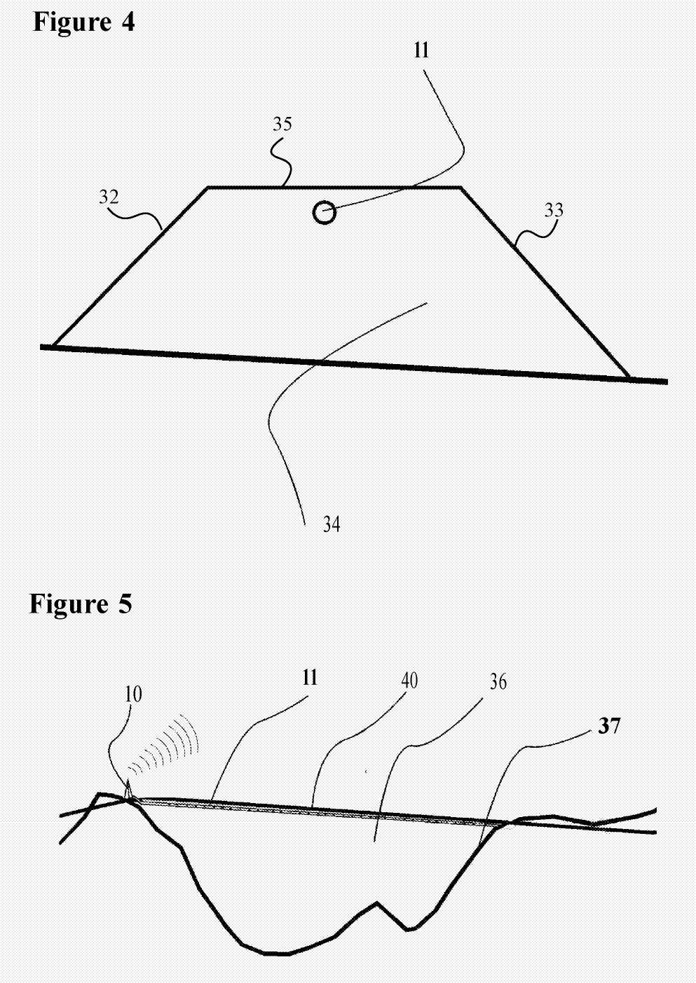

FIG. 4 is a cross section diagram of an earth fill dam having an upstream wall 32, a downstream wall 33, an earth core 34 and a viaduct upper drainage surface 35. The elongate housing 11 is installed in a 30 cm deep trench near the top of the fill material 34.

FIG. 5 is a section diagram along a highway fill batter. Fill material 36 has been placed over the original ground surface 37 to create a new highway surface stabilised by a rock formed batter. The elongate housing 11 is placed in a shallow trench on the highway shoulder. The base reference station 10 is installed on undisturbed ground.

Apparatus and methods of the foregoing embodiment has the advantage that the elevation of a multiplicity of points is continuously measured. Real time monitoring allows alarms to be triggered if subsidence values exceed preset limits. Instrumentation is permanently buried in the ground and can continue to operate for many years without interfering with use of the surface. The method of the invention is more accurate and much less costly than alternative methods.

### CITATION LIST

### Non Patent Literature

Land Subsidence in the United States (1999) United States Geological Service Circular 1182. Edited by Devin Galloway. David R. Jones and S. E. Ingebritsen http://pubs.usgs.gov/circ/1999/1182/report.pdf Retrieved August 2016 Pages 141-158 review methods for monitoring and measuring subsidence.

Real Time Monitoring of Subsidence along 170 in Washington Pennsylvania (2000) Authors: Kevin M. O'Connor, Ronald J. Clark, David J. Whitlatch and Charles H. Dowding http://www.iti.northwestern.edu/tdr/publications/Dowding_et_al-2001-Real _Time_Monitoring_of_Infrastructure_of_Subsidence_Along_I-70_in_Washington_PA.pdf retrieved August 2016.

Background paper on subsidence monitoring and measurement with a focus on coal seam gas (CSG) activities. (2013) Paper prepared for the NSW Chief Scientist and Engineer. Authors: Simon McClusky and Paul Tregoning Research School of Earth Sciences The Australian National University Canberra. http://www.chiefscientist.nsw.gov.au/_data/assets/pdf_file/0016/33028/Subsidence-Monitoring _McClusky-Tregoning_ANU.pdf Retrieved August 2016. Chapter 2 (pages 9-31) reviews methods for monitoring and measuring subsidence.

Monitoring and management of subsidence induced by coal seam gas extraction. (2014) Review prepared by Coffey Geotechnics Pty Ltd and revised by the Commonwealth Government Department of the Environment following peer review. https://www.environment.gov.au/system/files/resources/632cefef-0e25-4020-b337-80a9932d1c67/files/knowledge-report-csg-extraction_0.pdf Retrieved August 2016 Chapter 11 (pages 90-117) reviews methods for monitoring and measuring subsidence

1. A method of monitoring elevation along a traverse over an earthen ground substrate, said method comprising:
establishing a base reference point of known elevation on said traverse from which an elongate housing extends along a length of said traverse, said housing adapted to be buried in the substrate and having an interior protected from the environment along the traverse;
selecting a plurality of measurement points along said traverse;
interconnecting said base reference point and said plurality of measurement points by a pair of conduits extending from said base reference station through the interior of and substantially along a length of said elongate housing, each said conduit being filled with a respective one of a pair of fluids having different densities, wherein one of the pair of fluids is a gas;
continuously monitoring data corresponding to a pressure difference between the pair of fluids at said base reference point and each of said plurality of measurement points over a network;
relating said data for each of said measurement points to said known elevation to form a database of elevations; and
monitoring said database of elevations for changes in elevation at one or more of said measurement points.

2. The method of claim 1, wherein the base reference point is monitored by external means selected from high precision radar altimetry, GPS and laser measurement, any variation in externally-derived elevation data for the base reference point being used to calibrate the database of elevations.

3. The method of claim 1, wherein the plurality of measurement points are evenly distributed at a selected pitch along the traverse.

4. The method of claim 1, wherein the conduits each comprise a tube of a material selected from polyamide 11 or 12, HDPE or low/medium density polyethylene resin pipe.

5. The method of claim 1, wherein the fluids are water and air respectively.

6. The method of claim 1, wherein the continuously monitoring data is by electronic pressure sensors.

7. The method of claim 6, wherein the electronic pressure sensors are piezo transducer devices interconnected on a data bus comprising said network.

8. The method of claim 7, wherein the piezo transducer devices are each a single, differential-pressure, smart transducer assembly.

9. The method of claim 8, wherein each differential-pressure, smart transducer assembly has a digital output selected from RS232, RS485, and CANbus compatible outputs.

10. (canceled)

11. The method of claim 1, wherein the continuously monitoring data is performed collectively by monitoring means associated with the base reference point.

12. The method of claim 11, wherein the monitoring means includes a microprocessor and reports a recorded pressure at each transducer to a central data processor when polled.

13. The method of claim 12, wherein the relating of the data for each of said measurement points to said known elevation to form the database of elevations is done by said central data processor.

14. (canceled)

15. The method of claim 13, wherein the database of elevations is monitored for changes in elevation at one or more of the measurement points via interface with the central data processor by user interrogation, automatic signalling or both.

16. The method of claim 1, wherein the conduits and the network are located in an elongate housing having an interior protected from the environment along the traverse.

17. (canceled)

18. An elevation monitoring apparatus for a traverse over an earthen ground substrate, said apparatus comprising:
a base reference station located at a base reference point of known elevation on said traverse;
an elongate housing extending from said base reference station along a length of said traverse, said housing adapted to be buried in the substrate, said housing having an interior protected from the environment along the traverse;
a pair of conduits, each said conduit being filled with a respective one of a pair of fluids having different densities, wherein one of the pair of fluids is a gas, said conduits extending from said base reference station through the interior of and substantially along a length of said elongate housing;
a plurality of pressure sensors spaced along the pair of conduits and selected to sense a pressure difference between the fluids at said base reference station and at a plurality of measurement points along said traverse defined by said sensors;
monitoring means for continuously monitoring and collecting data corresponding to said pressure difference between the fluids at said pressure sensors over a network;
data processing means relating said data for each of said measurement points to said known elevation to form a database of elevations; and
output means for monitoring said database of elevations and producing an output of changes in elevation at one or more of said measurement points.

19. The apparatus of claim 18, wherein the base reference station comprises a housing adapted to protect internal components from the environment and be securely located at the base reference point.

20. The apparatus of claim 18, wherein the point of known elevation is monitored by GPS with an antenna co-located with the housing, any variation in externally-derived elevation data for the base reference point being used to calibrate the database of elevations.

21. (canceled)

22. The apparatus of claim 18, wherein the conduits are formed of a polymer selected from polyamide 11 or 12, HDPE and low/medium density polyethylene resin.

23. The apparatus of claim 18, wherein the fluids comprise water and air.

24. The apparatus of claim 18, wherein the plurality of pressure sensors are piezo transducer devices.

25-36. (canceled)
